(19) United States
(12) Patent Application Publication
(10) Pub. No.: US 2006/0285071 A1
(43) Pub. Date: Dec. 21, 2006

(54) Femtosecond laser micromachining of a contact lens and a contact lens manufactured thereby

(75) Inventors: Paul M. Erickson, Rochester, NY (US); Jay F. Kunzler, Canandaigua, NY (US); Joseph C. Salamone, Fairport, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/158,150

(22) Filed: Jun. 21, 2005

(51) Int. Cl. G02C 7/04

(52) U.S. Cl. 351/160 R

(57) ABSTRACT

A method of providing a feature on a contact lens including applying a femtosecond laser beam to ablate at least a portion of the contact lens to provide the feature on the contact lens. In one embodiment, the femtosecond laser beam has a pulse width between 10×10⁻¹⁵ seconds and 200×10⁻¹⁵ seconds, and has a wavelength between 100 nm and 1500 nm. A contact lens is also provided including at least one fenestration fluidically connecting the anterior surface and the posterior surface, the fenestration being formed using a femtosecond laser in a manner that areas surrounding the fenestration are substantially free of heat damage.

### BACKGROUND OF THE INVENTION

1. Field of the Invention

The invention is directed to a method for manufacturing contact lenses. In particular, the invention is directed to a method for laser micromachining contact lenses to provide features thereon. In addition, the invention is also directed to a contact lens manufactured in accordance with the method.

2. Description of Related Art

Contact lenses have been commonly used by individuals to correct their eyesight for many years. Various contact lenses are available to consumers including daily wear and extended wear soft contact lenses, as well as hard contact lenses. Contact lenses include a lens body with an anterior surface, and a posterior surface that contacts the surface of the eye. It is also known to provide fenestrations on the contact lenses. The fenestrations define openings which extend through the lens body to provide pathway for fresh, oxygenated tears to flow to the surface of the eye to enhance comfort to the contact lens wearer.

An example contact lens is illustrated and described in U.S. Pat. No. 6,010,219 to Stoyan that discloses a contact lens including a lens body with an anterior surface and a posterior surface. Stoyan discloses a contact lens in which the posterior surface has a central portion and a tear portion that defines a tear reservoir for storing tears between the contact lens and the surface of the eye. The reference further discloses fenestrations that define openings which extend through the lens body and are open to the tear reservoir. The reference discloses that the fenestrations allows fluid communication and pressure release between the anterior and posterior surfaces of the contact lens.

Various techniques have been proposed for providing features on a contact lens. For example, U.S. Pat. No. 4,563,565 to Kampfer et al. discloses a method for forming a peripheral edge on a contact lens using a laser. U.S. Pat. No. 3,833,786 to Brucker, and U.S. Pat. No. 3,971,910 to Marschalko et al. describe apparatuses for providing fenestrations on a contact lens using a laser. The lasers described in Bucker and Marschalko et al. are of the CO₂ type in which a concentrated laser beam is used to burn through the lens to provide the fenestrations. However, the described apparatuses have not gained in commercial popularity due to the fact that the concentrated laser also causes the surrounding areas of the contact lens to be damaged from the heat of the laser.

U.S. Pat. No. 5,293,186 to Seden et al. also discloses a contact lens in which a particular type of laser is used to provide fenestrations in the contact lens. In particular, Seden et al. discloses the use of an excimer laser at a number of fixed wavelengths of 193 nm, 248 nm, and 308 nm in the ultraviolet wavelength range, and preferably, between 160 nm and 230 nm. The reference further discloses that the laser is pulsed so that laser beam has pulse width typically of the order of ten nanoseconds (10×10⁻⁹ seconds). The reference asserts that the unique combination of ultraviolet output and high peak power can remove the materials of a contact lens through ablation. Thus, with an excimer laser, Seden et al. asserts that the material can be removed with very high precision, and with virtually no heat-affected portion in the surrounding regions of the contact lens.

Excimer lasers as described in Seden et al. have been found to be superior to conventional methods of providing features on a contact lens such as by drilling or using conventional CO₂ lasers. Use of a laser does not produce sharp edges, burrs or other particles of removed material that result from drilling. Such edges, burrs, or particles of removed material can cause discomfort to the wear of the contact lens. However, excimer lasers, while being superior to conventional methods, have also been found to be inadequate in providing fenestrations. In particular, even when excimer lasers such as that disclosed in Seden et al. is used to provide fenestrations on a contact lens, minor heat related damage to the surrounding regions of the contact lens results which may negatively impact the performance of the contact lens.

Therefore, there still exists an unfulfilled need for a method for laser micromachining contact lenses to provide features such as fenestrations thereon, with minimal heat related damage to the surrounding regions of the contact lens.

### SUMMARY OF THE INVENTION

In view of the foregoing, an advantage of the invention is in providing a method for laser micromachining contact lenses to provide features such as fenestrations thereon.

Another advantage of the invention is in providing such a method in which the features are provided in the contact lens with minimal heat related damage to the surrounding regions of the contact lens.

These and other advantages are provided by a method of providing a feature on a contact lens in accordance with the invention. In particular, the method comprises applying a femtosecond laser beam to the contact lens to ablate at least a portion of the contact lens to provide the feature on the contact lens. In this regard, the contact lens may be located in a fixture. The invention may be used to provide features on a contact lens made of elastomeric silicone, rigid silicone, or other contact lens material.

In accordance with one embodiment of the method of the invention, the femtosecond laser beam has a pulse width between 10×10⁻¹⁵ seconds and 200×10⁻¹⁵ seconds, and preferably, between 60×10⁻¹⁵ seconds and 100×10⁻¹⁵ seconds. In another embodiment, the femtosecond laser beam has a wavelength between 100 nm and 1500 nm, and preferably, between 266 nm and 1060 nm.

Ablating of the contact lens by the laser beam may include cutting, melting and/or vaporizing a portion of the contact lens, and is attained without measurably increasing the temperature of a surrounding area of the contact lens. The method of the invention may be used to provide any appropriate feature on the contact lens. For example, the method may be used to provide fenestrations, channels, and/or angulations on the contact lens, or used to form the peripheral edge of the contact lens.

In one embodiment, the feature provided is a fenestration that extends though the contact lens between an anterior surface of the contact lens and a posterior surface of the contact lens. The fenestration may be any desired size. For example, the invention may be used to provide a fenestration having a diameter between 4 μm and 24 μm, and preferably between 8 μm and 12 μm. The fenestration may have a diameter at the anterior surface of the contact lens that is different than a diameter at the posterior surface.

In accordance with another aspect of the invention, a method of manufacturing a contact lens is provided comprising locating a contact lens in a fixture, and applying the femtosecond laser beam to the located contact lens to ablate at least a portion of the contact lens. In one implementation, the femtosecond laser beam has a pulse width between 60×10⁻¹⁵ seconds and 100×10⁻¹⁵ seconds, and has a wavelength between 266 nm and 1060 nm. The present method may be used to form a fenestration having a diameter between 8 μm and 12 μm.

In accordance with still another aspect of the invention, a contact lens is provided including a central portion having an anterior surface and a posterior surface, a peripheral portion having a peripheral edge, and at least one fenestration fluidically connecting the anterior surface and the posterior surface, the fenestration being formed using a femtosecond laser in a manner that areas surrounding the fenestration are substantially free of heat damage. In accordance with one embodiment, the fenestration has a diameter between 4 μm and 24 μm. In one preferred embodiment, the femtosecond laser generates a laser beam having a pulse width between 10×10⁻¹⁵ seconds and 160×10⁻¹⁵ seconds, and a wavelength between 266 nm and 1060 nm.

### BRIEF DESCRIPTION OF THE DRAWINGS

FIG. 1 is an anterior end view of a contact lens manufactured using the method in accordance with the invention.

FIG. 2 is a cross-sectional view of the contact lens of FIG. 1 being manufactured using the method of the invention.

### DETAILED DESCRIPTION OF THE PREFERRED EMBODIMENT

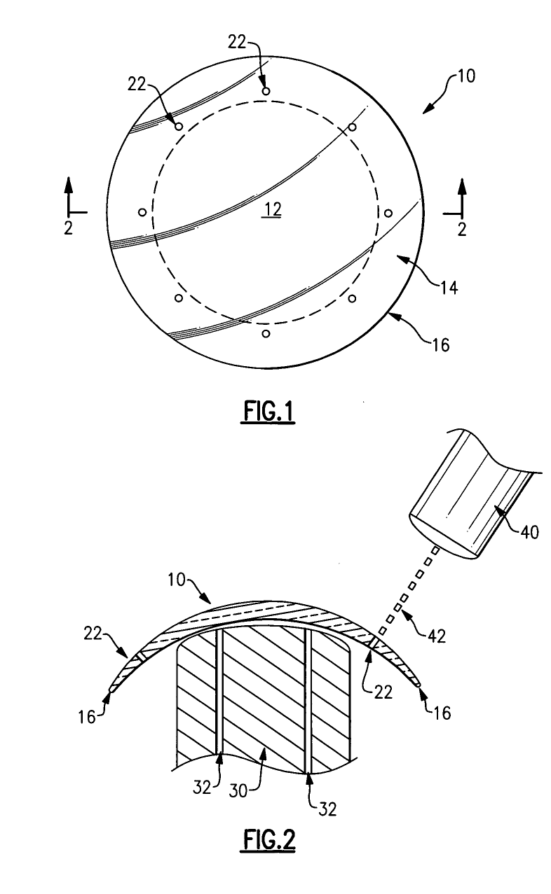

FIG. 1 shows an anterior end view of a contact lens 10 suitable for being manufactured using the method in accordance with the invention. FIG. 2 is an enlarged cross-sectional view of the contact lens 10 of FIG. 1 as viewed along 2-2 being manufactured using the method of the invention. As explained below, an advantage of the invention is in providing a method for laser micromachining contact lens 10 to provide various features thereon. In this regard, the invention allows provision of features such as fenestrations, channels, and/or angulations on the contact lens 10 that are substantially free of heat related damage to the surrounding regions. Of course, the method of the invention may be used to provide different features on the contact lens, for example, to manufacture the peripheral edge of the contact lens.

As shown in FIGS. 1 and 2, the illustrated example contact lens 10 includes a central portion 12 that covers the cornea of the wearer of the contact lens 10 to correct the wearer's vision, the central portion 12 being schematically defined by the dashed circle in FIG. 1. The contact lens 10 also includes a peripheral portion 14 that surrounds the central portion 12 and has a peripheral edge 16. The outside diameter of the contact lens 10 is approximately 10 mm, but in other embodiments, can vary between about 5 to 20 mm, based on the dimensions of the wearer's eyes and the corrective prescription. Contact lens 10 also has a lateral or cross-sectional thickness of in the range of 0.05 to 0.5 mm. However, in other embodiments, the lateral thickness may vary between approximately 0.05 mm to 1.0 mm, based on the corrective prescription, and the overall diameter of the contact lens.

The central portion 12 includes an anterior surface 18 and a posterior surface 20 which is most clearly shown in FIG. 2, the posterior surface 20 being generally concaved to receive the wearer's cornea therein. The curve of the posterior surface 20 in the central portion 12 may be spherical, aspheric, or alternatively designed corresponding to the desired optical characteristics as set forth in the corrective prescription. The anterior surface 18 of the central portion 12 which may be spherical or aspheric depending on the corrective prescription, has a radius of curvature which may, or may not, match the radius of the posterior surface 20.

A plurality of fenestrations 22 are provided in the illustrated contact lens 10 shown in FIGS. 1 and 2, the plurality of fenestrations 22 extending though the contact lens 10 between the anterior surface 18 and the posterior surface 20. In the illustration, only eight fenestrations 22 are provided around the central portion 12, the fenestrations 22 being symmetrically spaced 45° apart. However, any desired number of fenestrations which are arranged in any desired manner may be provided in other implementations. The fenestrations 22 of the illustrated implementation are tubular in shape with circular cross sections with diameters between 4 μm and 24 μm, and preferably, between 8 μm and 12 μm. However, the fenestrations 22 may be of any desired size and shape to provide effective fluidic communication between the anterior surface 18 and the posterior surfaces of the contact lens 10. Of course, the figures are not to scale, and the diameters of the fenestrations are exaggerated for clear illustration.

The contact lens 10 may be made from any appropriate material known in the art for contact lenses such as conventional polymers used in the manufacture of oxygen permeable hard, semi-hard, and soft hydrogel corneal contact lenses. For example, contact lens 10 may be made from elastomeric silicone or rigid, gas permeable silicone. The contact lens 10 may be made according to any of the known machining or molding processes which allow aspheric or spherical curvature lenses to be formed. For instance, the contact lens 10 may be machined from buttons or disks as known in the art.

It should be noted that the central portion 12 and the peripheral portion 14 can be made from the same material or different materials. Thus, a suitable contact lens 10 could include a hard plastic central portion 12 while the remaining portions are made from a semi-hard or soft material. The use of different materials for different portions of the contact lens 10 allows further control over corneal reshaping or molding.

As described in further detail below, the invention provides a method for laser micromachining contact lenses such as contact lens 10 shown, to provide features such as fenestrations 22 thereon. In contrast to the prior art, the laser micromachining in accordance with the invention is attained with minimal heat related damage to the surrounding regions of the contact lens 10. In this regard, FIG. 2 shows a cross-sectional view of the contact lens 10 being manufactured using the method of the invention.

As shown in FIG. 2, the method comprises locating the contact lens 10, for example, in a fixture 30, and using a femtosecond laser 40 to generate a femtosecond laser beam 42. The fixture 30 can be any device for locating and maintaining the position of the contact lens 10 so that the femtosecond laser beam 42 can be accurately positioned and applied. In this regard, the fixture 30 of the illustrated embodiment includes vacuum channels 32 that creates suction to secure the contact lens 10 on the fixture 30. It should also be noted that the femtosecond laser 40 is a pulsed laser. Correspondingly, the femtosecond laser beam 42 is schematically illustrated in FIG. 2 as a plurality of discrete laser bursts.

The femtosecond laser 40 that generates the femtosecond laser beam 42 can be used with any appropriate laser/optics equipment such as lenses, mirrors, etc. to direct the laser beam 42 to the contact lens 10. In addition, the femtosecond laser 40 may be used in conjunction with conventional laser apparatuses such as those described in U.S. Pat. No. 3,833,787 to Brucker, U.S. Pat. No. 3,971,910 to Marschalko et al., and U.S. Pat. No. 4,563,565 to Kampfer et al. Moreover, whereas only one femtosecond laser 40 is shown in the implementation of FIG. 1, the method of the invention may also be practiced using a plurality of femtosecond lasers to provide various features on the contact lens 10.

The femtosecond laser beam 42 is applied to the located contact lens 10 at a desired location to thereby ablate a portion of the contact lens 10. It should be understood that ablation of the contact lens 10 by the femtosecond laser beam 42 may include cutting, melting and/or vaporizing a portion of the contact lens 10. As can be appreciated, in the illustrated example, the femtosecond laser beam 42 is used to create the fenestrations 22 on the contact lens 10. However, as noted, the presently described method using the femtosecond laser 40 may be applied to provide any desired features such as, but not limited to, channels, and/or angulations on the contact lens 10, and/or used to form the peripheral edge 16 of the contact lens 10.

The fenestrations 22 shown extends though the contact lens 10 between the anterior surface 18 of the contact lens 10, and a posterior surface 20 of the contact lens 10. The provided fenestrations 22 may be of any desired size. For example, the fenestrations 22 may have diameters between 4 μm and 24 μm, and preferably, may have diameters between 8 μm and 12 μm. It should be noted that the fenestration 22 may have a diameter at the anterior surface 18 of the contact lens 10 that is different than a diameter at the posterior surface 20.

According to the invention, the use of a femtosecond laser beam 42 allows providing of fenestrations 22 on the contact lens 10 without measurably increasing the temperature of a surrounding area of the contact lens 10 so that the surrounding area is substantially free of heat damage. Such heat that is generated when using conventional long wave lasers of the prior art, including excimer lasers, causes heat damage in the surrounding areas, and can negatively impact the performance of the contact lens 10.

More specifically, to prevent heat damage to the areas surrounding the fenestrations 22 of the contact lens 10 during the laser micromachining process, the femtosecond laser beam 42 has a pulse width between 10×10⁻¹⁵ seconds and 200×10⁻¹⁵ seconds. Preferably, the pulse width is between 60×10⁻¹⁵ seconds and 100×10⁻¹⁵ seconds. As can be appreciated, this pulse width is over 1000 times shorter than the pulse width of ten nanoseconds (10×10⁻⁹ seconds) that is disclosed in the prior art. In addition, the femtosecond laser beam 42 has a wavelength between 100 nm and 1500 nm, and preferably, between 266 nm and 1060 nm. One femtosecond laser that is capable of providing the femtosecond laser beam in accordance with the present method is commercially available from Clark-MXR, Inc. in Dexter, Mich. (www.cmxr.com).

The above described laser micromachining by ablating a portion of the contact lens 10 using the femtosecond laser beam 42 allows formation of the fenestrations 22 without measurably increasing the temperature of a surrounding area of the contact lens 10 so that heat damage to the areas surrounding the fenestrations 22 does not occur. Thus, the invention allows fenestrations 22 to be provided without negatively impacting the performance of the contact lens 10.

Of course, it should be noted that whereas the method in accordance with the invention have been described relative to providing fenestrations for contact lens 10, the method of the invention is not limited thereto. The laser micromachining method of the invention using a femtosecond laser can be applied as a significantly improved method to provide any appropriate feature on a contact lens 10. For example, the present method may be utilized to form the peripheral edge 16 of the contact lens 10 such as that described in U.S. Pat. No. 4,563,565 to Kampfer et al. In addition, the present method may further be used to provide angulations and/or channels that extend on the anterior and/or posterior surfaces of the contact lens.

The above described method of the invention to provide features on the contact lens 10 may be implemented during any appropriate stage of manufacturing the contact lens 10. For example, the body of the contact lens 10 may be machined from buttons or disks that are mounted to the fixture 30. The mounted positioning of the contact lens 10 can be maintained with the anterior surface 18 of the contact lens 10 resting on the fixture 30 so that the location of the contact lens 10 is fixed and known. The femtosecond laser 40 can then be actuated to provide the femtosecond laser beam 42 which is applied to the contact lens 10 to form the features on the contact lens 10 in the manner described above. After completing application of the femtosecond laser beam 42 to form the desired features on the contact lens 10, the contact lens 10 can be further processed, for example, cleaned, tested, and sanitized for packaging.

While various embodiments in accordance with the invention have been shown and described, it is understood that the invention is not limited thereto. The invention may be changed, modified and further applied by those skilled in the art. Therefore, this invention is not limited to the detail shown and described previously, but also includes all such changes and modifications.

We claim:

1. A method of providing a feature on a contact lens comprising:
applying a femtosecond laser beam to a contact lens to ablate at least a portion of said contact lens to create said feature on said contact lens.

2. The method of claim 1, wherein said femtosecond laser beam has a pulse width between 10×10⁻¹⁵ seconds and 200×10⁻¹⁵ seconds.

3. The method of claim 2, wherein said femtosecond laser beam has a pulse width between 60×10⁻⁵ seconds and 100×10⁻¹⁵ seconds.

4. The method of claim 1, wherein said femtosecond laser beam has a wavelength between 100 nm and 1500 nm.

5. The method of claim 4, wherein said femtosecond laser beam has a wavelength between 266 nm and 1060 nm.

6. The method of claim 1, wherein ablating of said contact lens by said femtosecond laser beam includes at least one of cutting, melting and vaporizing a portion of said contact lens by said femtosecond laser beam.

7. The method of claim 1, wherein ablating of said contact lens by said femtosecond laser beam is attained without measurably increasing the temperature of a surrounding area of said contact lens.

8. The method of claim 1, wherein said feature provided is at least one of a fenestration, a channel, an angulation, and a peripheral edge.

9. The method of claim 8, wherein said feature provided is a fenestration.

10. The method of claim 9, wherein said fenestration has a diameter between 4 μm and 24 μm.

11. The method of claim 10, wherein said fenestration has a diameter between 8 μm and 12 μm.

12. The method of claim 9, wherein said fenestration extends though said contact lens between an anterior surface of said contact lens and a posterior surface of said contact lens.

13. The method of claim 12, wherein said fenestration has a diameter at said anterior surface of said contact lens that is different than a diameter at said posterior surface.

14. The method of claim 1, wherein said contact lens is made of elastomeric silicone.

15. The method of claim 1, wherein said contact lens is made of rigid, gas permeable silicone.

16. The method of claim 1, further including locating said contact lens in a fixture.

17. A method of manufacturing a fenestration in a contact lens comprising:
locating a contact lens in a fixture; and
applying a laser beam having a pulse width between 10×10⁻¹⁵ seconds and 160×10⁻¹⁵ seconds, and a wavelength between 266 nm and 1060 nm to said located contact lens to ablate at least a portion of said contact lens to form said fenestration on said located contact lens, said fenestration extending though said contact lens between an anterior surface of said contact lens and a posterior surface of said contact lens, and having a diameter between 8 μm and 12 μm.

18. A method of manufacturing a contact lens comprising:
locating a contact lens in a fixture; and
applying a femtosecond laser beam to said located contact lens to ablate at least a portion of said contact lens.

19. The method of claim 18, wherein said femtosecond laser beam has a pulse width between 60×10⁻¹⁵ seconds and 100×10⁻¹⁵ seconds.

20. The method of claim 18, wherein said femtosecond laser beam has a wavelength between 266 nm and 1060 nm.

21. The method of claim 18, wherein said ablated portion forms at least one of a fenestration, a channel, an angulation, and a peripheral edge.

22. The method of claim 21, wherein said ablated portion is a fenestration having a diameter between 8 μm and 12 μm.

23. A contact lens comprising:
a central portion having an anterior surface and a posterior surface;
a peripheral portion having a peripheral edge; and
at least one fenestration fluidically connecting said anterior surface and said posterior surface, said at least one fenestration being formed using a femtosecond laser in a manner that areas surrounding said at least one fenestration are substantially free of heat damage.

24. The contact lens of claim 23, wherein said at least one fenestration has a diameter between 4 μm and 24 μm.

25. The contact lens of claim 23, wherein said femtosecond laser generates a laser beam having a pulse width between 10×10⁻¹⁵ seconds and 160×10⁻¹⁵ seconds.

26. The contact lens of claim 23, wherein said femtosecond laser generates a laser beam having a wavelength between 266 nm and 1060 nm.
